(19) United States
(12) Patent Application Publication
(10) Pub. No.: US 2005/0288098 A1
(43) Pub. Date: Dec. 29, 2005

(54) Detachable keypad for electronic game-control console

(76) Inventor: Kin Man Tse, Kowloon (HK)

Correspondence Address: ALIX YALE & RISTAS LLP, 750 MAIN STREET, SUITE 1400, HARTFORD, CT, 06103, US

(21) Appl. No.: 10/891,899

(22) Filed: Jul. 14, 2004

(30) Foreign Application Priority Data
Jun. 25, 2004 (GB) 0414286.5

(51) Int. Cl. A63F 13/00

(52) U.S. Cl. 463/37

(57) ABSTRACT

A detachable keypad for an electronic game-control console (18), includes a body (10) supporting a number of alphanumeric keys (11) that when depressed communicate signals to a processor. A claw (9) extends from the body (10) and has fingers (17 and 17′) for grasping the console (18) so as to support the body (10) on the console (18).

### BACKGROUND OF THE INVENTION

The present invention relates to a detachable keypad for an electronic game-control console. More particularly, although not exclusively, the invention relates to a keypad that can be attached to and removed from a game-control console for television video games.

It is known to user-control video game devices such as the Sony PlayStation II™ using a console attached via a cable to a game processor/disk drive unit. It is also known to communicate with the processor/disk drive with a separate third-party or “aftermarket” keyboard or keypad. Such keypads are useful when the game processor is connected to the Internet for the purpose of playing on-line games with a remote competitor or competitors.

The console and a separate keyboard/keypad are cumbersome to manipulate, as players often sit on a lounge chair or floor in front of a television monitor to which the processor/disk drive is connected and must swap the components back and forth as required during the game.

### OBJECT OF THE INVENTION

It is an object of the present invention to overcome or substantially ameliorate the above disadvantage and/or more generally to provide a detachable keypad for an electronic game-control console.

### SUMMARY OF THE INVENTION

There is disclosed herein a detachable keypad for an electronic game-control console, comprising:
a body supporting a plurality of keys and having communication means for communicating depression of the keys to a processor, and
a claw extending from the body and comprising fingers for grasping said game-control console so as to support the body thereupon.

Preferably, the fingers are resilient.

Preferably, the communication means comprises a flexible cable.

Preferably, the body comprises a slot and the claw comprises a tongue received by the slot to secure the claw to the body.

Preferably, the tongue comprises a resilient clip for snap-engagement with the body.

Preferably, the claw comprises a platform from which the fingers extend and upon which the tongue is located, the platform bearing against a surface of the body when the tongue is received by the slot.

Preferably, the fingers are curved to extend partially about said game-control console.

Preferably, the claw comprises a pair of spaced apart fingers at one side thereof and a single opposed finger at the other side thereof and aligned in between the pair of fingers.

Preferably, the fingers are resilient.

Preferably, the keypad comprises a plurality of alphanumeric keys and one or more arrow keys.

### BRIEF DESCRIPTION OF DRAWINGS

A preferred form of the present invention will now be described by way of example with reference to the accompanying drawings, wherein:

FIG. 1 is a parts-exploded perspective view of an embodiment of a keypad in accordance with the invention, having a body and a claw;

FIG. 2 is a perspective view of the assembled keypad body and claw of FIG. 1 and a game-control console to which the keypad body is to be attached by the claw; and

FIG. 3 is a perspective view of the keypad attached to the game-control console of FIG. 2.

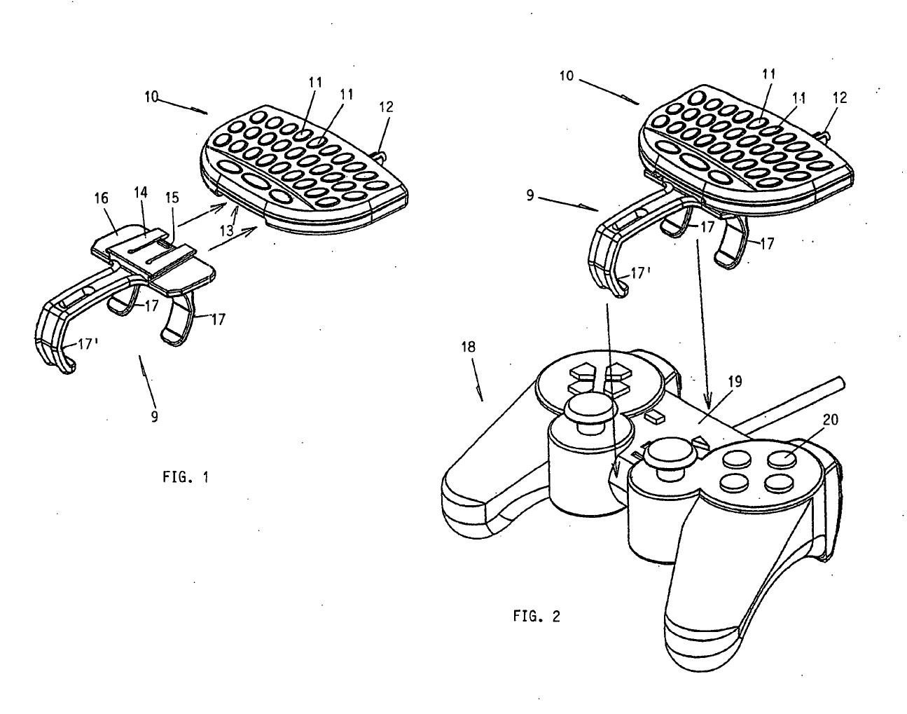

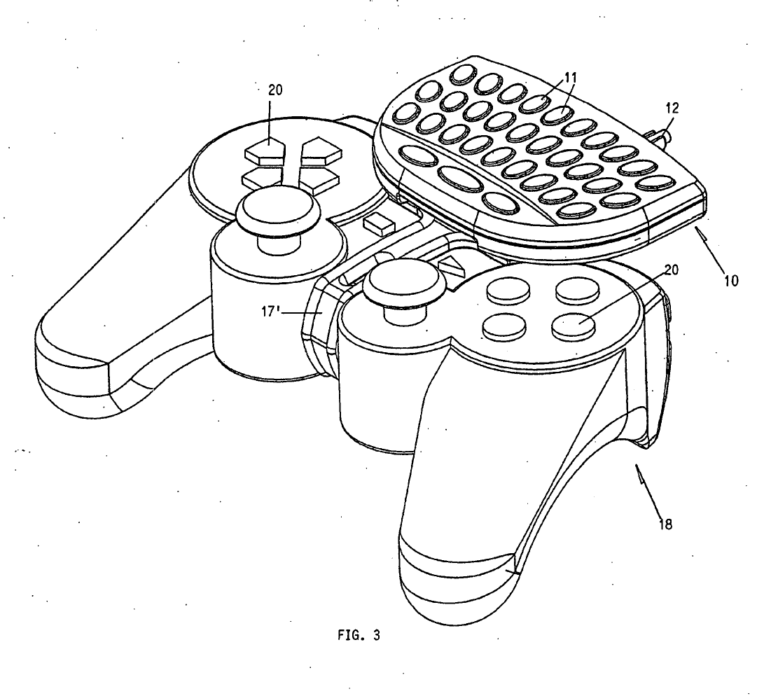

### DETAILED DESCRIPTION OF PREFERRED EMBODIMENT

Referring to the drawings, there is shown a keypad embodying the invention, which has a body 10 and a number of keys 11 thereon. The body 10 is typically formed of moulded plastics material. Some of the keys 11 would include alphanumeric indicia, whereas others might include directional arrows or an “Enter” indicia for example. A flexible cable 12 extends from the body 10 to communicate key depressions to a game processor/disk drive unit (not shown). In the bottom surface of the body 10, there is a central slot 13.

A plastics claw 9 is attached to the bottom surface of the body 10 by means of a tongue 14 that slides into the slot 13. The tongue 14 comprises a central resilient clip 15 that snap-engages into a depression (not shown) formed in the bottom of the body 10 within the slot 13. The claw 9 includes a platform 16 upon which the tongue is located. The flat portions of the platform flanking the tongue bear upon the bottom surface of the body 10 when the tongue 14 slides into slot 13. Extending from the platform 16 are three resilient curved fingers 17 and 17′. There are two spaced apart fingers 17 at one side of the platform 16 and a single opposing central finger 17′ at the other side of the platform.

The fingers 17 and 17′ resiliently engage about the centre portion 19 of a game-control console 18 to support the body 10 thereabove. The game-control console 18 has a number of keys 20 that remain user-accessible when the body 10 is attached thereto.

It should be appreciated that modifications and alterations obvious to those skilled in the art are not to be considered as beyond the scope of the present invention. For example, rather than providing resilient fingers, the fingers could be more rigid and capable of user-reconfiguration and tightening—say in a sliding manner.

1. A detachable keypad for an electronic game-control console, comprising:
a body supporting a plurality of keys and having communication means for communicating depression of the keys to a processor, and
a claw extending from the body and comprising fingers for grasping said game-control console so as to support the body thereupon.

2. The keypad as claimed in claim 1, wherein the fingers are resilient.

3. The keypad as claimed in claim 1, wherein the communication means comprises a flexible cable.

4. The keypad as claimed in claim 1, wherein the body comprises a slot and the claw comprises a tongue received by the slot to secure the claw to the body.

5. The keypad as claimed in claim 4, wherein the tongue comprises a resilient clip for snap-engagement with the body.

6. The keypad as claimed in claim 4, wherein the claw comprises a platform from which the fingers extend and upon which the tongue is located, the platform bearing against a surface of the body when the tongue is received by the slot.

7. The keypad as claimed in claim 1, wherein the fingers are curved to extend partially about said game-control console.

8. The keypad as claimed in claim 1, wherein the claw comprises a pair of spaced apart fingers at one side thereof and a single opposed finger at the other side thereof and aligned in between the pair of fingers.

9. The keypad as claimed in claim 8, wherein the fingers are resilient.

10. The keypad as claimed in claim 1, wherein the keypad comprises a plurality of alphanumeric keys and one or more arrow keys.
